(19) United States
(12) Patent Application Publication
(10) Pub. No.: US 2006/0240383 A1
(43) Pub. Date: Oct. 26, 2006

(54) Instruments for the treatment of radicular dental canals

(76) Inventors: Pierre-Luc Maillefer, Ballaigues (CH); Francois Aeby, Montagny-pres-Yverdon (CH)

Correspondence Address: Douglas J. Hura, Esquire;DENTSPLY International Inc., 570 West College Avenue, P.O. Box 872, York, PA, 17405-0872, US

(21) Appl. No.: 11/471,805

(22) Filed: Jun. 21, 2006

Related U.S. Application Data
(63) Continuation of application No. 10/773,363, filed on Feb. 6, 2004.

(30) Foreign Application Priority Data
Sep. 4, 2000 (EP) 00119102.2

(51) Int. Cl. A61C 5/02

(52) U.S. Cl. 433/102

(57) ABSTRACT

Instrument for the treatment of the apical portion of radicular dental canals, has a conical shaft (1) having at least one helicoidal working ridge. The active anterior portion (2) of the instrument is comprised of at least two successive cones whose opening (,X) decreases from the anterior point (3) of the instrument in the direction of its active posterior portion.

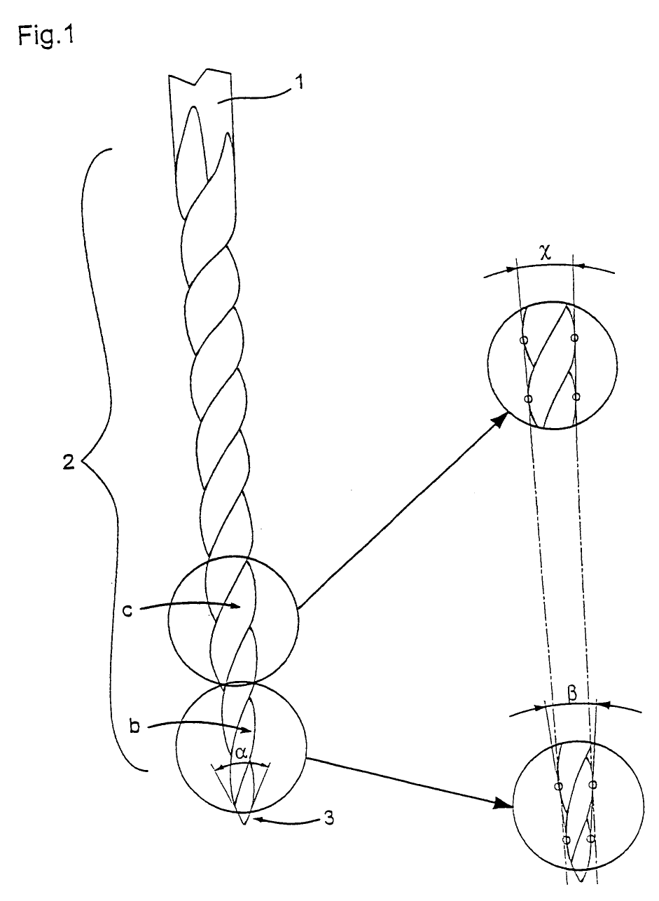

### TECHNICAL FIELD

The present invention has for its object an instrument for the treatment of radicular dental canals, comprising a tapered shaft having over at least a portion of its length, constituting its active portion, at least one helicoidal ridge for cutting or treatment.

### BACKGROUND OF THE INVENTION

The treatment of an infected dental root is carried out by extraction of the pulp with the aid of specific instruments (for example, nerve extractors, Hedstroem, NiTi or nickel-titanium rotatable instruments), then by shaping the canal, by means of successive bores with the aid of instruments of variable size and conicity. The last operation consists in closing the canal (for example, using Gutta Percha cone, amalgam, cement).

The shaping of the canal consists in the first instance in providing an enlargement of the canal in its coronary and median portions to permit, in a second instance, treating the apical portion of the canal more easily by mechanical cleaning of the infected tissues.

The first phase, namely the enlargement of the canal, can take place according to different methods. The so called “Step back” method consists in passing into the canal a succession of instruments whose diameter increases, by reducing the bored length at each increase of the diameter.

This process requires a long time to accomplish. Moreover, this method leads to a bore with a stair-step channel, which is hardly desirable. The second method, called “Crown-Down” consists in first enlarging the coronary part of the radicular canal, then in penetrating, by means of a series of instruments that are thinner and thinner, to the apical region. Here again, this operation requires a long time, but has the advantage of reducing the risk of fracturing the instruments. A third method is proposed, which uses a concept of instruments with several conicities of flared shape, thin and tapered at the point and wide and of marked conicity at the end of the cutting portion turned toward the handle. Such a tool permits the practitioner rapidly to shape the radicular canal, because he can, in order to do this, use only a small number of instruments, as is described in Swiss patent CH-689.996 of the applicant, rather than a large number of instruments of different sizes and shapes.

The second phase of this shaping of the radicular canal consists in preparing the apical region of the canal. A marked conicity is desirable here, so as to have a sufficiently great volume to obtain optimum closure of the canal. The conicity of the preparation decreases in the direction from the coronary portion of the canal.

### SUMMARY OF THE INVENTION

The object of the present invention is to provide a series of instruments permitting shaping of the dental canal with the aid of a small number of instruments so that this operation can be carried out more rapidly, with less stress for the dental practitioner and with complete safety for the patient, and which is distinguished by the characteristics set forth in claim 1.

### BRIEF DESCRIPTION OF THE DRAWINGS

The accompanying drawing shows schematically and by way of example an embodiment of the instrument according to the invention.

The single FIGURE shows the working point of the instrument according to the invention.

### PREFERRED EMBODIMENT FOR CARRYING OUT THE INVENTION

With reference to the accompanying drawing, the instrument according to the invention, adapted to permit the dental practitioner increased working comfort in the second phase of shaping the canal, namely flaring of the apical portion, is distinguished by the fact that it comprises a conical shaft 1 having at least one helical working ridge, cutting or non-cutting. The active portion 2 of the instrument, of a length generally greater than about 14 mm, comprises an envelope enclosing within two or a plurality of cones whose opening reduces (or outer size or diameter increases) from the point 3 of the tool in the direction of its posterior portion.

Such an instrument therefore has a terminal portion, several millimeters long on the anterior working portion 2, comprising a generally ogival or curved and tapered shape.

Thus with a set of instruments, two or three instruments of this type and of a diameter increasing from one instrument to the other, generally comprised between about 0.1 mm and about 3 mm at the point of the instrument, the dental practitioner can shape the apex of practically all the radicular canals encountered.

Often, a single instrument of the present set of instruments will suffice for shaping the apical portion of a given radicular canal.

These instruments can be provided for manual use with a handle or for mechanized use comprising a posterial portion adapted to be driven in rotation by a handpiece.

As is seen more particularly in the drawing, the angle of the cone of the envelope of the extreme end 3 of the instrument, is greater than the angle or representing the conicity of the instrument at positions b and c of the active portion of the instrument located farther to the rear, namely in the direction of the handle of the instrument.

With such an instrument, it is possible to form an apical portion of the dental canal having a large conicity of about 4 percent to about 6 percent, which permits good closure. Thus, the volume created being greater, one can more easily close all the openings and interstices so as to render the canal substantially or totally sealed, thereby to avoid any post-operative infection.

1. An instrument for the treatment of the apical portion of radicular dental canals, comprising a conical shaft having at least one helicoidal working ridge,
and having an active anterior portion comprising at least two successive cones whose opening decreases from an anterior point of the instrument in the direction of said active posterior portion.

2. An instrument according to claim 1, wherein said active portion comprises a plurality of cones of different openings, of a value decreasing from the point of the instrument and thus has the general shape of an ogive whose point forms the point of the instrument.

3. An instrument according to claim 1, wherein said active portion has a length greater than about 14 mm.
